(19) United States
(12) Patent Application Publication
(10) Pub. No.: US 2025/0340186 A1
(43) Pub. Date: Nov. 6, 2025

(54) DRYING SYSTEM AND METHOD FOR A VEHICLE CARWASH

(71) Applicant: Motor City Wash Works, Inc., Wixom, MI (US)

(72) Inventor: Lionel Belanger, Northville, MI (US)

(73) Assignee: Motor City Wash Works, Inc., Wixom, MI (US)

(21) Appl. No.: 18/656,155

(22) Filed: May 6, 2024

(51) Int. Cl. B60S 3/00; B60S 3/06

(52) U.S. Cl. CPC B60S 3/002; B60S 3/066

(57) ABSTRACT

A vehicle drying system and method is adapted for use in an automated carwash and includes a rotary drying wheel assembly defining a wheel axis and having disc shaped drying elements including outer and inner elements where the outer elements have a larger diameter than the inner drying elements thus allowing for better drying the sides of a vehicle including side mirrors of the vehicle when the rotary drying wheel assembly is in a horizontal orientation. The system and method may further include a control system adapted to control movement of the rotary drying wheel assembly including rotation of the drying wheel assembly in a first direction and a second direction opposite of the first direction for purpose of better reaching into and drying inward angled side mirrors of the vehicle. The control system may further include a sensor for detecting the position of the vehicle and the vehicle's height.

### TECHNICAL FIELD

The invention generally relates to vehicle cleaning systems and methods and more particularly to a vehicle drying system and method for use in a carwash including a horizontal rotary drying wheel assembly having portions of a drying material extending in differing lengths and adapted to dry both a top and sides of the vehicle including the vehicle's side mirrors.

### BACKGROUND

Various carwash cleaning systems are well known. This includes cloth-type vehicle laundering implements having an axel or driveshaft including a plurality of circular fabric disks as taught in U.S. Pat. No. 8,082,618 and incorporated herein by reference as if rewritten herein word for word. Other similar systems are known and provide suitable cleaning of a vehicle in a carwash. Some systems include a horizontal driveshaft that rotates a cleaning material which cleans, including washing or drying of the vehicle's hood, roof, and trunk portion. Systems using a vertical orientation are also available. The cleaning material is typically a fabric that extends from the driveshaft in a substantially uniform radius. The cleaning material may be assembled using long strips of fabric or circular fabric disk elements. As the driveshaft rotates, the cleaning material is used to wash or dry the sides, roof, hood, and opposite end of the vehicle (typically trunk area), as well as vertical surfaces, windows, and wheels. The cleaning material is power driven by rotating the axel or driveshaft.

Such well known systems are challenged when used to attempt drying the side windows of the vehicle and even more challenged when attempting to dry the driver and passenger side mirrors of the vehicle and including the window area proximate to the side mirrors. The difficulty lies in the presenting angle of the side mirrors which are angled at least partially inwardly towards the interior of the vehicle. As the cleaning assembly rotates the cleaning material is substantially blocked from reaching the side mirrors' surface. In a horizontal orientation the cleaning materials do not reach far enough down along the sides of the vehicle to reach the side mirrors or the side windows. Further, in a drying application, the cleaning materials typically rotate towards the back of the vehicle thus removing moisture from the vehicle surface rather than pushing it forward onto the previously dried part of the vehicle. By rotating towards the back of the vehicle the cleaning materials is prevented from reaching the interior area of the side mirrors or the area of side windows next to the side mirrors.

Therefore, there is an opportunity to improve carwash cleaning systems including a drying system and method that overcomes the limitations and disadvantages that exist with current cleaning systems.

### SUMMARY

It is an advantage of the present invention to provide a vehicle drying assembly and method that is better adapted to dry a vehicle in a carwash, particularly including the sides of a vehicle and more particularly the side mirrors and side windows proximate to the side mirrors. Even more particularly, the assembly and method are adapted to dry the mirror surfaces of side mirrors including surfaces of side mirrors angled inward towards the vehicle.

It is another advantage of the present invention to change the rotation direction of the drying assembly at least momentarily for the purpose of reaching into the area around the side mirrors for effecting better drying of the side mirrors. The system being adapted to return to a normal direction of rotation after drying the side mirrors.

It is another advantage of the present invention to monitor the position of the vehicle and identify or approximate where the side mirrors are located in order to change the rotation direction of the drying assembly at the appropriate location to dry the side mirrors.

It is another advantage of the present invention to provide for drying of the side mirrors of a vehicle with an apparatus adapted to dry top, side and side mirror surfaces of the vehicle with one apparatus thus removing the need for a separate apparatus to clean including drying the side mirror of the vehicle.

It is another advantage of the present invention to control the starting and stopping of the drying apparatus in response to an amount of torque encountered by the drying wheel assembly. In this embodiment, the system is adapted to prevent damage to the vehicle being dried and the drying system.

It is another advantage of the present invention to monitor the height of the vehicle and adjust the movement of the drying system to better accommodate a particular vehicle type.

Other advantages will become clear in relation to the detailed description of the invention and including the drawings.

In accordance with the above and other advantages of the present invention, a drying assembly and method for use in a vehicle carwash is provided. In a nonlimiting embodiment of the invention, a rotary drying wheel assembly defining a substantially horizontal wheel axis and adapted to dry a vehicle's driver and passenger side mirrors includes a driveshaft adapted to be disposed in substantially horizontal driven relationship with a rotary actuator. The rotary drying wheel assembly further includes a first disc shaped outer drying element having a first diameter and disposed on the driveshaft for rotational movement therewith at an axial position proximate a first end of the driveshaft, a second disc shaped outer drying element having a second diameter, the second diameter being substantially equal to the first diameter, the second outer drying element disposed on the driveshaft for rotational movement therewith at an axial position proximate a second end of the driveshaft. The rotary drying wheel assembly further includes at least one disc shaped inner drying element having a third diameter, the third diameter being less than the first diameter, the at least one inner drying element disposed on the driveshaft for rotational movement therewith at an axial position between the first end and the second end, wherein a ratio of the first diameter to the third diameter is at least 1.05:1.

In a nonlimiting embodiment, the rotary drying wheel assembly includes where the first outer drying element is a plurality of drying elements, and where the second outer drying element is a plurality of drying elements, and where the third outer drying element is a plurality of drying elements.

In a nonlimiting embodiment, the rotary drying wheel assembly includes where the first outer drying element, the second outer drying element, and the third outer drying element are composed of a non-cloth material.

In a nonlimiting embodiment, the rotary drying wheel assembly includes where a ratio of the first diameter to the third diameter is greater than 1.05:1.

In a nonlimiting embodiment, the rotary drying wheel assembly includes where a ratio of the first diameter to the third diameter is at least 1.20:1.

In a nonlimiting embodiment, the invention includes a system for drying a vehicle in an automated wash facility including a rotary actuator, a rotary drying wheel assembly defining a wheel axis and having a first end and a second end. The rotary drying wheel assembly includes a driveshaft disposed in driven relationship with the rotary actuator. The rotary drying wheel assembly further includes a first outer drying element having a first diameter and disposed on the driveshaft for rotational movement therewith at an axial position proximate the first end. The rotary drying wheel assembly further includes a second outer drying element having a second diameter, the second diameter being substantially equal to the first diameter, the second outer drying element disposed on the driveshaft for rotational movement therewith at an axial position proximate the second end. The rotary drying wheel assembly further includes at least one inner drying element having a third diameter, the third diameter being less than the first diameter, the at least one inner drying element disposed on the driveshaft for rotational movement therewith at an axial position between the first end and the second end.

The system further includes a control system configured to supply a drive signal to the rotary actuator. The control system includes a vehicle position sensor configured to generate a position signal representing a position of the vehicle relative to the rotary drying wheel assembly. The control system further includes a controller in communication with the vehicle position sensor and the rotary actuator, wherein the controller is configured to supply a first drive signal to the rotary actuator in response to receiving a first position signal that the vehicle is in a first position, and further configured to supply a second drive signal to the rotary actuator in response to receiving a second position signal that the vehicle is in a second position.

In a nonlimiting embodiment the system includes where the controller is further configured to supply a third drive signal to the rotary actuator in response to receiving a position signal that the vehicle is in a third position. In another nonlimiting embodiments, a ratio of the first diameter to the third diameter is at least 1.05:1.

In a nonlimiting embodiment, the system includes where the first drive signal is configured to rotate the rotary drying wheel assembly in a first direction. In another nonlimiting embodiment, the second drive signal is configured to rotate the rotary drying wheel assembly in a second direction, the second direction being opposite the first direction.

In a nonlimiting embodiment, the system further includes a support assembly supporting the rotary drying wheel assembly and a height actuator coupled to the support assembly and configured to move the rotary drying wheel assembly relative to a floor surface. In a nonlimiting embodiment, the control system further includes a vehicle height sensor in communication with the controller and is configured to generate a height signal representing a height of the vehicle, where the controller is further configured to supply a height drive signal to the height actuator in response to receiving a first height signal from the vehicle height sensor. In a nonlimiting embodiment, the support assembly includes a base and an arm pivotably coupled to the base, wherein the height actuator is operatively arranged between the base and the arm. In a nonlimiting embodiment the rotary actuator is coupled to the arm.

In another nonlimiting embodiment the system includes where the rotary drying wheel assembly further include a plurality of spacers with one of the plurality of spacers are arranged between each of the first and second outer drying elements and the at least one inner drying element. In a nonlimiting embodiment, the at least one inner drying element is further defined as a plurality of inner drying elements, wherein one of the plurality of spacers is arranged between each of the plurality of inner drying elements.

In another nonlimiting embodiment the system includes where each of the first outer drying element and the second outer drying element include a hub coupled to one of the driveshaft and a spacer where the spacer is coupled to the driveshaft for rotational motion therewith and a drying material ring is coupled to the hub and extending away from the wheel axis. In another nonlimiting embodiment, the cloth ring comprises a non-woven material having a series of folds radially arranged about the wheel axis to define the cloth ring.

In a nonlimiting embodiment of a method of the invention for operating a drying system includes a rotary drying wheel assembly rotatable by a rotary actuator about a wheel axis and has a pair of outer drying elements defined by a first diameter and an inner drying element defining a second diameter less than the first diameter arranged between the pair of outer drying elements for drying a vehicle in an automated wash facility and further includes a control system having a controller and a vehicle position sensor in communication with the controller. The method includes generating, with the vehicle position sensor, a first position signal representing a vehicle in a first position relative to the drying wheel assembly. In the next step of the method, supplying, from the controller, a first drive signal to the rotary actuator for rotating the drying wheel assembly in a first rotation in response to the first position signal. In the next step of the method, generating, with the vehicle position sensor, a second position signal representing a vehicle in a second position relative to the drying wheel assembly. In the next step of the method, supplying, with the controller, a second drive signal to the rotary actuator for rotating the drying wheel assembly in a second rotation when the vehicle is in the second position, the second rotation being opposite from the first rotation.

In a nonlimiting embodiment of the method, where the first rotation is different from the second rotation in at least one of a rotation speed and a rotation direction. In a nonlimiting embodiment, the first rotation is in a direction opposite to a direction of vehicle travel, and wherein the second rotation is in the same direction as the direction of vehicle travel. In a nonlimiting embodiment, the second position corresponds to alignment between the wheel axis and an exterior feature of the vehicle. In another nonlimiting embodiment, the exterior feature of the vehicle is further defined as an exterior mirror.

In another nonlimiting embodiment of the method, further includes a step of supplying, with the controller, a third drive signal to the rotary actuator for rotating the drying wheel assembly in a third rotation when the vehicle is in a third position. In another nonlimiting embodiment of the method, the third position corresponds to alignment between the wheel axis and an exterior feature of the vehicle. In another nonlimiting embodiment, the exterior feature of the vehicle is further defined as a rear window. In another nonlimiting embodiment of the method the rotary actuator includes a torque measurement in communication with the control system. The method further comprising detecting torque of the rotary drying wheel assembly by the torque measurement and stopping or reversing the rotary drying wheel assembly in response to the torque measurement. In another nonlimiting embodiment of the method the control system is in communication with a vehicle height sensor adapted to measure the height of the vehicle as it travels through a carwash. In this embodiment, the method further includes measuring the height of the vehicle and directing the movement of the drying wheel assembly to accommodate the height of the vehicle.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic-type perspective view of a carwash drying system of a nonlimiting embodiment of the invention;

FIG. 2 is a side view of the drying system of FIG. 1;

FIG. 3 is another side view of the drying system of FIG. 1;

FIG. 4 is a front perspective view of discs of a drying wheel assembly of the drying system of FIG. 1;

FIG. 5 is a side view of the drying wheel assembly of the drying system of FIG. 1;

FIG. 6 is an exploded view of the drying wheel assembly of FIG. 5;

FIG. 7 is a perspective view of a component of the drying wheel assembly of FIG. 6;

FIG. 8 is a side detailed cutout view of a portion of one of the discs of the drying wheel assembly of the FIGS; and

FIG. 9 is a flowchart of a carwash drying method of a nonlimiting embodiment of the invention.

### DETAILED DESCRIPTION

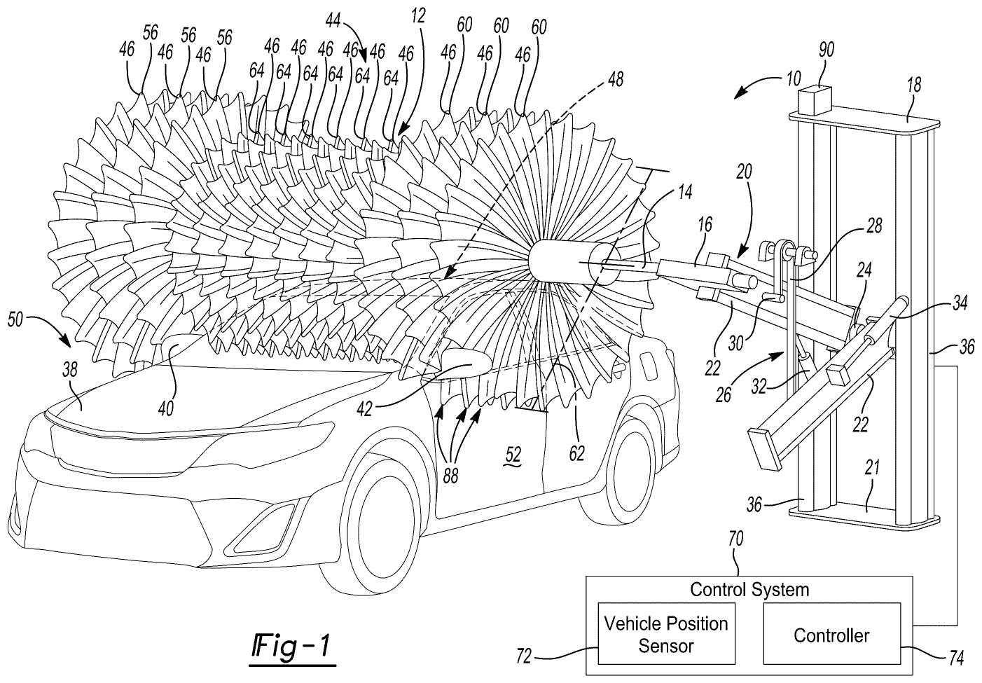

Referring to FIGS. 1-3, a vehicle drying system 10 according to a nonlimiting embodiment of the invention is provided. The vehicle drying system 10 is part of a car washing system, including a mobile or stationary carwash as well known to someone of ordinary skill in the art. The vehicle drying system 10 includes a rotary drying wheel assembly 12, which includes a driveshaft 14. The rotary drying wheel assembly 12 is in rotatable association with a rotary actuator 16. The rotary drying wheel assembly 12 and the rotary actuator 16 are associated with a support assembly 18 configured to support and allow movement of the rotary drying wheel assembly 12 relative to a floor surface. In a nonlimiting embodiment the support assembly 18 is connected to a floor (not shown in FIG. 1) of a carwash. Alternatively, the support assembly 18 may be freestanding or associated with the ceiling of the carwash, or in another form well known to someone of skill in the art. The support assembly 18 is shown as a single freestanding apparatus but could take many different forms including two frame assemblies with one frame assembly on each end of the rotary drying wheel assembly 12, or other forms as well known to a person of ordinary skill in the art.

The support assembly 18 further includes a height actuator 20 coupled to the support assembly 18 and configured to move the rotary drying wheel assembly 12 relative to a base 21 on the floor of the carwash to accommodate the movement of vehicles of differing shapes and sizes traversing the carwash. The height actuator 20 includes articulating arms 22. The articulating arms 22 move in pivoting cooperation about a central pivot rod 24 as directed by a translation assembly 26 including a belt 28 attached to the one of the articulating arms 22 at a first connection point 30 and to another of articulating arms 22 at a second connection point (unseen). The height actuator 20 further includes a first dampener 32 and a second dampener 34 where the first dampener 32 is associated with one of the articulating arms 22 at one end and a frame 36 at the other end, and where the second dampener 34 is associated with the second of the articulating arms 22 at one end and the frame 36 at the other end. The type and cooperative uses of the first and second dampener 32, 34 and the articulating arms 22 are well known to a person of ordinary skill in the art. In a nonlimiting embodiment, the height actuator 20 includes at least one articulating arm as known to a person of ordinary skill in the art. In operation, the height actuator 20 provides for substantially balanced and weightless movement of the rotary drying wheel assembly 12 in an upward and downward manner as the drying wheel assembly 12 rotates by way of the rotary actuator 16 to clean a vehicle 38 by following along the contours of the vehicle 38, including the hood, roof and trunk area of the vehicle 38. It should be understood that the vehicle 38 could be substantially any type of vehicle, including but not limited to cars, trucks, and sport utility vehicles that are suitable for being washed in a carwash. It should further be understood that the vehicle 38 and any portion thereof is well known prior art and not intended to be part of the invention or required in any of the claims as a claim element. It is common that vehicles such as the illustrated vehicle 38 have a passenger side-mirror 40 and a driver side-mirror 42. It is well known that in a carwash setting it is difficult to wash and dry the passenger side-mirror 40 and driver side-mirror 42 including mirror surfaces. The invention provides an improvement to carwashes by accomplishing an important part of the carwash process without requiring separate and specialized equipment or requiring a person to manually wash or dry a vehicle's sides windows and side mirrors.

The rotary drying wheel assembly 12 includes a drying material 44. The drying material 44 in a nonlimiting embodiment is a cloth such as a cotton cloth. In another nonlimiting embodiment the drying material 44 is a non-woven material as disclosed in U.S. Pat. No. 8,082,618 and incorporated herein by reference. Further, other non-cloth materials as well known to a person of ordinary skill in the art may be utilized including any media suitable for drying a vehicle. The drying material 44 is included as part of a plurality of drying material discs 46. As illustrated, the drying material discs 46 are not of uniform diameter as associated with the driveshaft 14. The drying material discs 46 have an expanded diameter on and near opposing ends of the driveshaft 14 as relative to the drying material discs 46 near the middle of the driveshaft 14. Advantageously, the non-uniformity of the drying material discs' diameters allows the drying material 44 of the drying material discs 46 to reach a roof 48 of the vehicle 38 and simultaneously down along a passenger's side 50 and a driver's side 52 of the vehicle 38. Thus, the rotary drying wheel assembly 12 is better adapted to drying the vehicle 38.

The rotary drying wheel assembly 12 includes a first outer drying element 56 having a first diameter 58 as associated with the driveshaft 14 for rotational movement with the driveshaft 14 and a second outer drying element 60 having a second diameter 62 substantially equal to the first diameter. The second outer drying element 60 being associated with the driveshaft 14 for rotational movement with the driveshaft 14. The rotary drying wheel assembly 12 further includes at least one inner drying element 64 having a third diameter 66 from the driveshaft 14 for rotational movement with the driveshaft 14 where the third diameter 66 is less than the first diameter 58 of the first and second outer drying elements 56, 60. In a nonlimiting embodiment, the ratio of the first diameter 58 to the third diameter 66 is at least 1.05:1. Other ratios may be adapted including greater ratios, for example a ratio of 1.20:1 and greater. Another example, is a ratio of 1.50:1 and greater. As an illustrated example and not a limitation, the driveshaft 14 is shown associated with seven inner drying elements 64. In a nonlimiting embodiment the number inner drying elements 64 accounts for more than one quarter of the total drying elements.

The vehicle drying system 10 further includes control system 70 configured to supply a drive signal to the rotary actuator 16 thus rotating the driveshaft 14 and the associated drying material discs 46. In a nonlimiting embodiment, the control system 70 includes electrical components, controllers, and other associated components as are well known to a person of ordinary skill in the art for supplying a drive signal to the rotary actuator 16 and thus rotating the driveshaft 14 and associated drying material discs 46. In another nonlimiting embodiment, the control system 70 includes hardware and software of a computer system including, but not limited to a processor, memory (RAM, ROM and storage memory), an operating system and application software as are well known or developable without undue experimentation by a person of ordinary skill in the art. The control system 70 may include computer system related communications hardware and software including hardware and software for wired or wireless communication as is well known to a person of ordinary skill in the art. Further, it should be appreciated that some of the aforementioned components of the control system 70 may be remotely located relative to where a carwash is located that houses the rotary drying wheel assembly 12.

The control system 70 is in communication with a vehicle position sensor 72 configured to generate a position signal representing a position of the vehicle 38 relative to the rotary drying wheel assembly 12. The vehicle position sensor 72 may take one of many forms well known to a person of ordinary skill in the art including, but not limited to a load cell, proximity sensor, IR LED, IR detector, or other light source photodetector may be used to detect the position of the vehicle 38. The control system 70 also includes a controller 74 in communication with the vehicle position sensor 72. The controller 74 is configured to supply drive signals to the rotary actuator 16. The controller 74 is of a type well known to a person of ordinary skill in the art. In a nonlimiting embodiment, the controller 74 is configured to supply a first drive signal to the rotary actuator 16 in response to receiving a first position signal that the vehicle 38 is in a first position 76 and further configured to supply a second drive signal to the rotary actuator 16 in response to receiving a second position signal that the vehicle is in a second position 78. For example, the first position could be recognizing that the front of the vehicle 38 is in position to cleaned by the rotary drying wheel assembly 12 and the first drive signal can be to activate rotation of the rotary drying wheel assembly 12. As a further example, the second position 78 could be where the vehicle 38 side mirrors 40, 42 are proximate the rotary drying wheel assembly 12 and the second drive signal is to reverse direction of the rotary drying wheel assembly 12 to better clean the side mirrors 40, 42. The controller 74 may further be configured to supply a third drive signal to the rotary actuator 16 that the vehicle 38 is in a third position (not shown) which may correspond to the vehicle 38 moving past where the rotary drying wheel assembly 12 can reach the side mirrors 40, 42 and the third drive signal may be to return the direction of rotation of the rotary drying wheel assembly 12 it its original rotation direction.

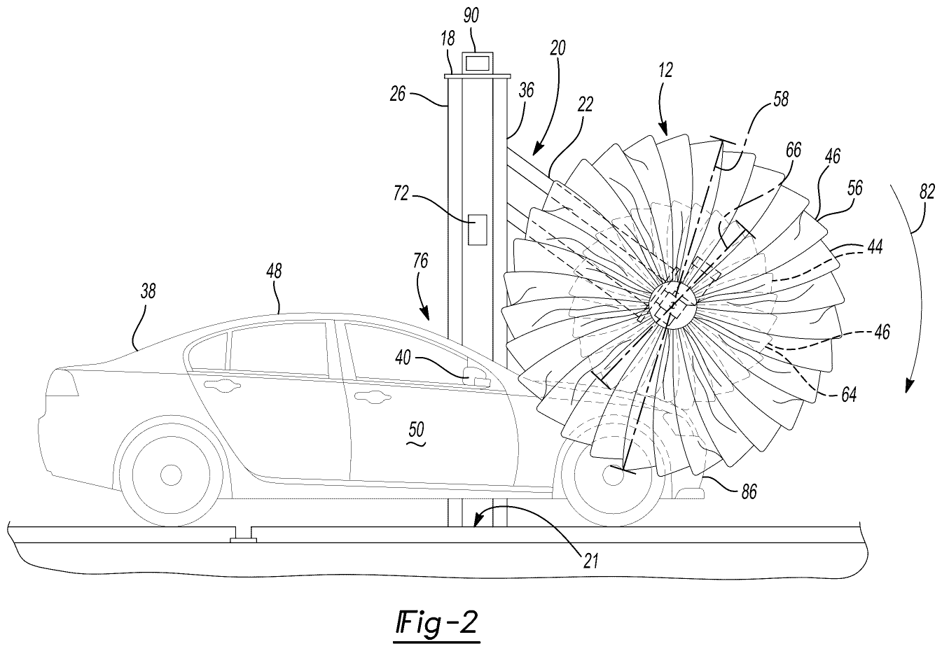

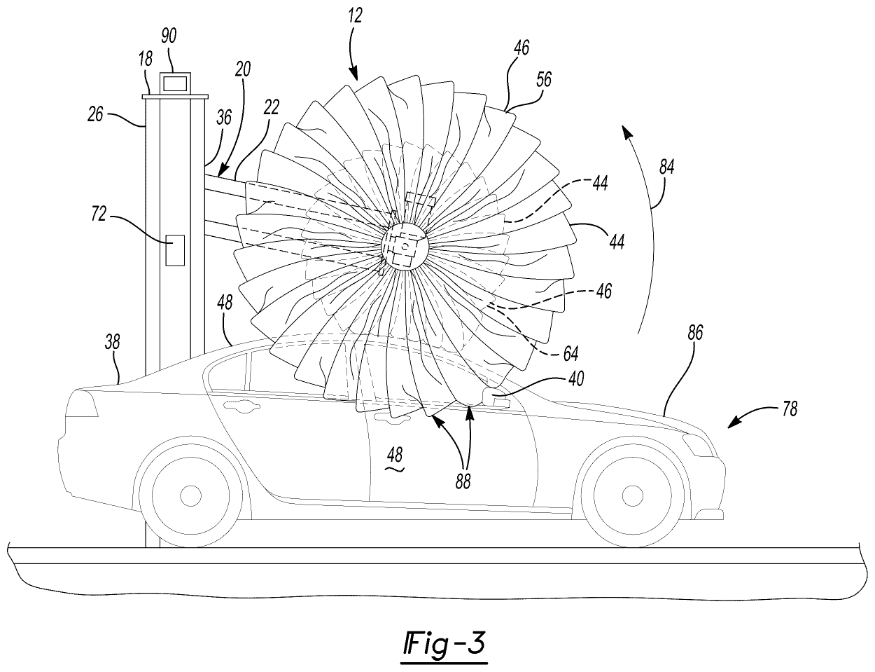

When the controller 74 supplies the first drive signal to the rotary actuator 16, the rotary drying wheel assembly 12 is rotated in a first direction 82. It should be appreciated that the first direction 82 may be a default direction of rotation and thus does not require a separate signal for the rotary drying wheel assembly 12 to rotate in the first direction 82. When the controller 74 supplies the second drive signal to the rotary actuator 16, the rotary drying wheel assembly 12 is rotated in a second direction 84 where the second direction 84 is opposite the first direction 82. As illustrated in FIG. 2, the first position 76 of the vehicle 38 is at or near where the vehicle 38 first encounters the rotary drying wheel assembly 12. As illustrated in FIG. 3, the second position of the vehicle 38 is at or near where the rotary drying wheel assembly 12 is contacting the passenger side-mirror 40 and the driver side-mirror 42. Importantly, outward ends 88 of the rotary drying wheel assembly 12 are in contact with an inner portion of the passenger side-mirror 40 and the driver side-mirror 42 thus facilitating the cleaning and drying of the mirrors. It should be appreciated that the first position 76, second position 78, and third position of the vehicle 38 are illustrated with a specific type of vehicle 38 but it is intended that the vehicle drying system 10 will adjust the positions to best accommodate the drying of a variety of types of vehicles including vehicles of differing shapes, sizes and heights. It is an advantage of the system of the invention to be able to accommodate different types of vehicles and their shapes, sizes, etc. and allow for cleaning, including drying of the side windows and side mirrors of the different vehicles. In a nonlimiting embodiment a ratio of the first diameter 58 to the third diameter 66 is at least 1.05:1. Other ratios may be adapted including greater ratios, for example a ratio of 1.20:1 and greater. Another example is a ratio of 1.50:1 and greater.

In a nonlimiting embodiment the control system 70 further includes a vehicle height sensor 90 in communication with the controller 74 and configured to generate a height signal representing a height of the vehicle 38. The height sensor 90 is of any type suitable for application in a carwash and is well known to a person of ordinary skill in the art. In this embodiment the controller 74 is further configured to supply a height drive signal to the height actuator 20 in response to receiving a first height signal from the vehicle height sensor 90. In response to the height drive signal, the height actuator 20 actuates the height of the rotary drying wheel assembly 12 to allow for the drying material 44 of the drying material discs 46 to contact and clean the vehicle 38 without damaging the vehicle 38 by the driveshaft 14 coming too close to the vehicle 38 or coming into contact with the vehicle 38.

In another nonlimiting embodiment, the vehicle position sensor 72 is a photoelectric eye well known to a person of ordinary skill in the art. The photoelectric eye is positioned so that as the vehicle 38 enters the carwash the front of the vehicle 38 will activate the vehicle position sensor 72 to identify the front of the vehicle 38 and communication this information to the controller 74. In this embodiment, the controller 74 is also in communication with a vehicle conveyor system of the type well known in the industry for conveying the vehicle through the carwash. The activation of the position sensor 72 identifying the front of the vehicle thus allows for coordinating the position of the vehicle 38 relative to the conveyor system. For example, and as well known in the art, the conveyor system may have a drive sprocket that typically has four pulses per revolution which corresponds to about eight inches (8″) of vehicle travel through the carwash per pulse. In this embodiment, the control system 70 knows where the front of the vehicle is in relation to the vehicle's movement by the conveyor system which allows the controller 74 to turn “on” and “off” the rotary drying wheel assembly 12 and move the rotary drying wheel assembly 12 in position to clean the vehicle 38. Further, in this embodiment, by knowing the location of the front of the vehicle 38 the control system 70 can approximate the location of the passenger side-mirror 40 and driver side-mirror 42 where the direction of the rotary drying wheel assembly 12 can be reversed, at least briefly to better dry the mirrors.

In another nonlimiting embodiment, the control system 70 is adapted to control the downward force on the vehicle 38. In this embodiment, the force to which the rotary drying wheel assembly 12 contacts the vehicle 38 is controlled to float over the surfaces of the vehicle 38 with an adjustable amount of pressure and penetration. In another nonlimiting embodiment, the control system 70 is adapted to control the rotations per minute (RPM) of the rotary drying wheel assembly 12.

In another nonlimiting embodiment, the rotary actuator 16 includes or is associated with a torque measure to detect an amount of torque encountered by the rotary drying wheel assembly 12 as it is rotating. The torque measurement is communicated to the control system 70 which allows for stopping the rotation of the rotary drying wheel assembly 12 in the event of too much torque which could indicate entanglement of the drying material 44 of one of the drying material discs 46 with an object such as a portion or the vehicle 38. As an example, a torque measurement in communication with the control system 70 would allow for stopping or reversing the rotary drying wheel assembly 12 if for example the drying material 44 becomes entangled with a vehicle windshield wiper.

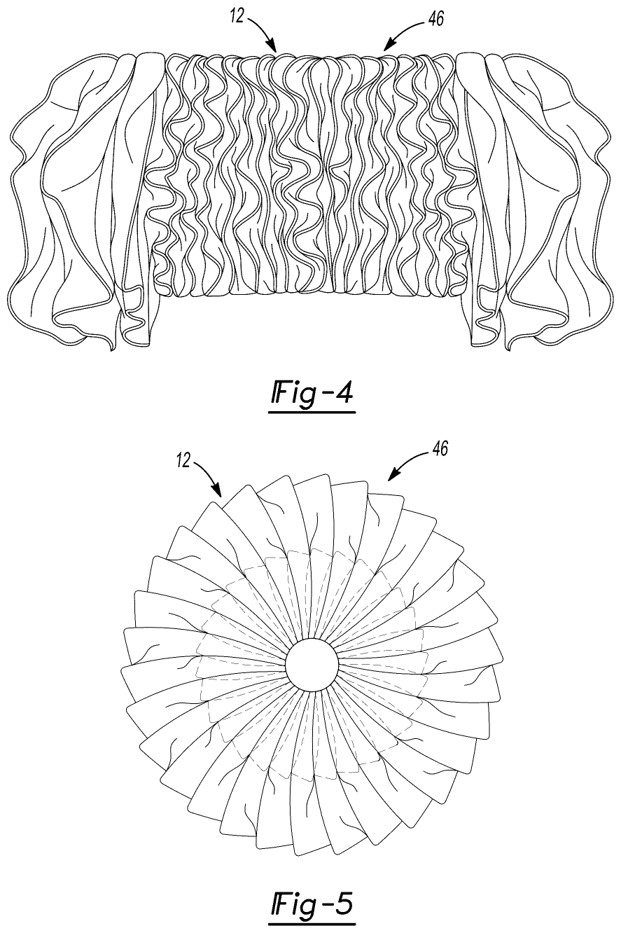

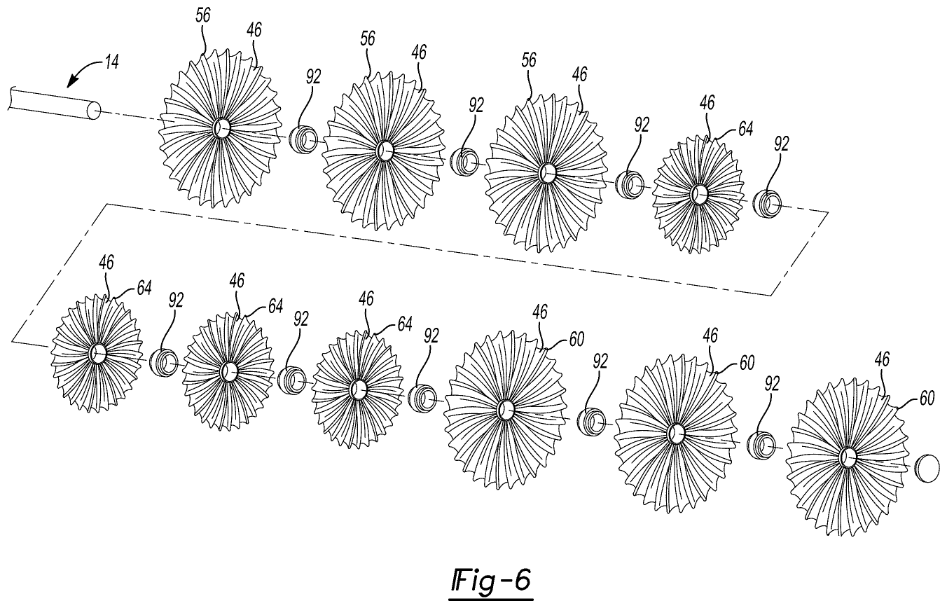

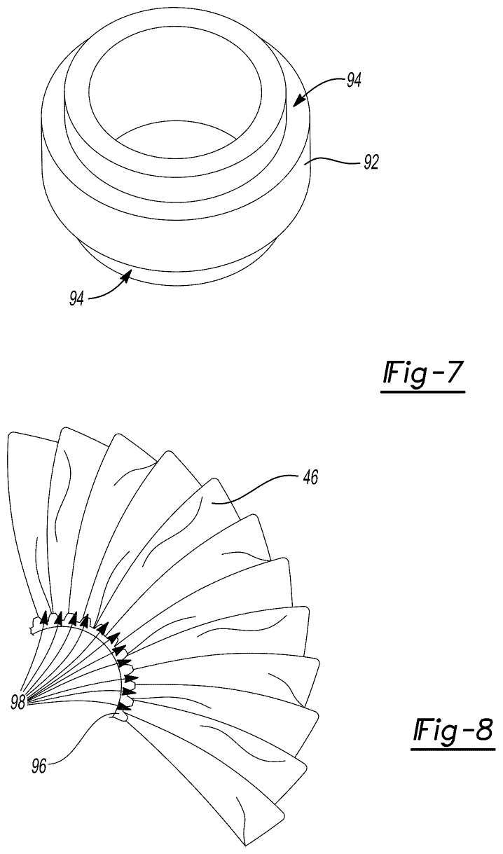

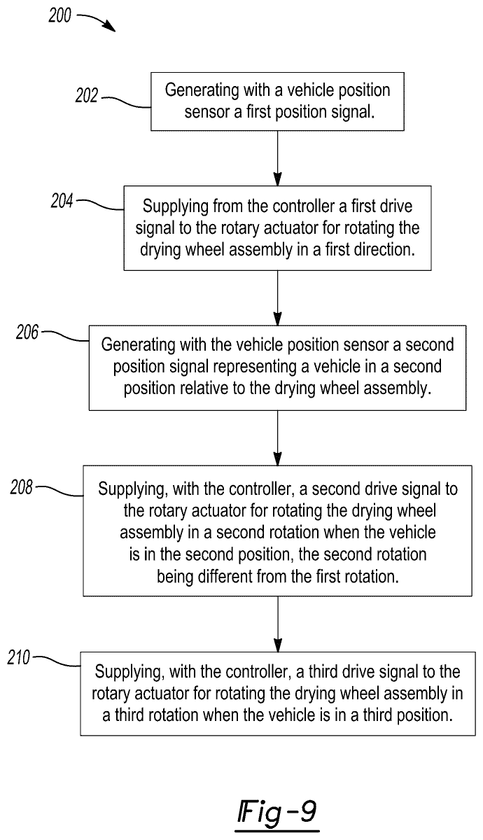

With reference to FIGS. 4-8, the rotary drying wheel assembly 12 further includes a plurality of spacers 92 arranged between each of the first and second outer drying elements 56, 60, and inner drying elements 66. The spacers 92 include a hub 94 on at least one end of each of the spacers 92 which are adapted to secure a media ring 96 of the drying material discs 46 to the spacers 92. Reference is again made to U.S. Pat. No. 8,082,618 and embodiments disclosed therein for examples of a coupling cloth or a non-woven material and other media to a drive shaft and to create a drying disc such as the drying material discs 46. In a nonlimiting embodiment the media ring 96 comprises a non-woven material having a series of folds 98 radially arranged about the wheel axis to define the media ring 96.

With added reference to FIG. 9, a nonlimiting embodiment of the invention is a method of operating a carwash drying system 200. The method 200 includes several of the previously described elements of the vehicle drying system 10 and is specifically suitable for application of drying the vehicle 38. The method 200 includes the rotary drying wheel assembly 12 rotatable by the rotary actuator 16, about a wheel axis such as the driveshaft 14. The rotary drying wheel assembly has a pair of outer drying elements 56, 60 defined by a first diameter 58 and an inner drying element 64 defining a second diameter 62 less than the first diameter arranged between the pair of outer drying elements 56, 60 for drying the vehicle 38 in an automated wash facility and further including a control system 70 having a controller 74 and a vehicle position sensor 72 in communication with the controller 74.

The method 200 includes a step 202 of generating with a vehicle position sensor a first position signal representing a vehicle in a first position relative to the rotary drying wheel assembly 12. The method 200, in the next step 204, includes supplying, from the controller, a first drive signal to the rotary actuator for rotating the rotary drying wheel assembly in a first rotation in response to the first position signal. The next step 206 includes generating, with the vehicle position sensor, a second position signal representing a vehicle in a second position relative to the drying wheel assembly. In a next step 208, the method 200 includes, supplying, with the controller, a second drive signal to the rotary actuator for rotating the drying wheel assembly in a second rotation when the vehicle is in the second position, the second rotation being opposite from the first rotation. As previously described, it is in the second rotation that the side mirrors of the vehicle are dried.

In a nonlimiting embodiment of the method 200, the first rotation is different from the second rotation in at least one of a rotation speed and a rotation direction. In another nonlimiting embodiment, the method 200 includes where the first rotation is in a first direction which is against a direction of vehicle travel, and where the second rotation is opposite the first direction. In another nonlimiting embodiment of the method 200 the second position corresponds to alignment between the wheel axis and an exterior feature of the vehicle. In another nonlimiting embodiment of the method 200, the exterior feature of the vehicle is further defined as an exterior mirror.

In another nonlimiting embodiment, the method 200 further includes the step 210 of supplying, with the controller, a third drive signal to the rotary actuator for rotating the drying wheel assembly in a third rotation when the vehicle is in a third position. The third position may correspond with the vehicle being past where the side mirror can be dried by the drying wheel assembly and the third rotation being the same as the first rotation. In another nonlimiting embodiment of the method 200, the third position corresponds to alignment between the wheel axis and an exterior feature of the vehicle. In another nonlimiting embodiment the method 200, includes where the exterior feature of the vehicle is further defined as a rear window.

In another nonlimiting embodiment, the method includes a vehicle height sensor 90 in communication with the controller 74. and the steps of determining a height of a front portion of a vehicle with the vehicle height sensor as the vehicle moves through the wash facility in proximity to the vehicle height sensor. The method also including setting a beginning height of the horizontal drying wheel assembly in response to the determination of the height of the front portion of the vehicle, and horizontally rotating the drying wheel assembly to dry the vehicle as the vehicle moves in proximity to the drying wheel assembly.

In another nonlimiting embodiment, the method of operating a drying system further includes, continuing to determine a height of additional portions of the vehicle with the vehicle height sensor as the vehicle moves through the wash facility in proximity to the vehicle height sensor, and continuing to adjust the height of the horizontal drying wheel assembly in response to the determination of the height of the additional portions of the vehicle as the vehicle moves through the wash facility in proximity to the vehicle height sensor.

In operation, the method 200 effectively dries the vehicle and allows for changing direction of the drying apparatus to better dry the side mirrors of the vehicle. The method 200 further allows for better accommodating the drying of side windows of the vehicle. In an embodiment, the method also allows for determining the height of the vehicle and adjusting the height of the drying apparatus to avoid damage to the drying apparatus and the vehicle, and to better dry the vehicle.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A rotary drying wheel assembly defining a substantially horizontal wheel axis and adapted to dry at least a portion of a vehicle's upper exterior side surfaces and including the vehicle's driver and passenger side mirrors, the rotary drying wheel assembly comprising:
a driveshaft adapted to be disposed in substantially horizontal driven relationship with a rotary actuator;
a first disc shaped outer drying element having a first diameter and disposed on the driveshaft for rotational movement therewith at an axial position proximate a first end of the driveshaft;
a second disc shaped outer drying element having a second diameter, the second diameter being substantially equal to the first diameter, the second outer drying element disposed on the driveshaft for rotational movement therewith at an axial position proximate a second end of the driveshaft; and
at least one disc shaped inner drying element having a third diameter, the third diameter being less than the first diameter, the at least one inner drying element disposed on the driveshaft for rotational movement therewith at an axial position between the first end and the second end, wherein a ratio of the first diameter to the third diameter is at least 1.05:1.

2. The rotary drying wheel assembly of claim 1, wherein the first outer drying element is a plurality of drying elements, wherein the second outer drying element is a plurality of drying elements, and wherein the third outer drying element is a plurality of drying elements.

3. The rotary drying wheel assembly of claim 1, wherein the first outer drying element, the second outer drying element, and the third outer drying element are composed of a non-cloth material.

4. The rotary drying wheel assembly of claim 1, wherein a ratio of the first diameter to the third diameter is greater than 1.05:1.

5. The rotary drying wheel assembly of claim 1, wherein a ratio of the first diameter to the third diameter is at least 1.20:1.

6. A system for drying a vehicle in an automated wash facility comprising:
a rotary actuator;
a rotary drying wheel assembly defining a substantially horizontal wheel axis and having a first end and a second end, the rotary drying wheel assembly including:
a driveshaft disposed in driven relationship with the rotary actuator;
a first outer drying element having a first diameter and disposed on the driveshaft for rotational movement therewith at an axial position proximate the first end;
a second outer drying element having a second diameter, the second diameter being substantially equal to the first diameter, the second outer drying element disposed on the driveshaft for rotational movement therewith at an axial position proximate the second end;
at least one inner drying element having a third diameter, the third diameter being less than the first diameter, the at least one inner drying element disposed on the driveshaft for rotational movement therewith at an axial position between the first end and the second end;
a control system configured to supply a drive signal to the rotary actuator, the control system comprising:
a vehicle position sensor configured to generate a position signal representing a position of the vehicle relative to the rotary drying wheel assembly; and
a controller in communication with the vehicle position sensor and the rotary actuator, wherein the controller is configured to supply a first drive signal to the rotary actuator in response to receiving a first position signal that the vehicle is in a first position, and further configured to supply a second drive signal to the rotary actuator in response to receiving a second position signal that the vehicle is in a second position.

7. The system of claim 6, wherein the controller is further configured to supply a third drive signal to the rotary actuator in response to receiving a position signal that the vehicle is in a third position.

8. The system of claim 6, wherein a ratio of the first diameter to the third diameter is at least 1.05:1.

9. The system of claim 6, wherein the first drive signal is configured to rotate the rotary drying wheel assembly in a first direction.

10. The system of claim 9, wherein the second drive signal is configured to rotate the rotary drying wheel assembly in a second direction, the second direction being opposite the first direction.

11. The system of claim 6, wherein each of the first outer drying element and the second outer drying element comprises a hub coupled to the driveshaft for rotational motion therewith and a media ring coupled to the hub and extending away from the wheel axis.

12. A method of operating a drying system including a horizontal drying wheel assembly rotatable by a rotary actuator about a wheel axis and having a pair of outer drying elements defined by a first diameter and an inner drying element defining a second diameter less than the first diameter arranged between the pair of outer drying elements for drying a vehicle in an automated wash facility and further including a control system having a controller and a vehicle position sensor in communication with the controller, the method comprising:
generating, with the vehicle position sensor, a first position signal representing a vehicle in a first position relative to the drying wheel assembly;
supplying, from the controller, a first drive signal to the rotary actuator for horizontally rotating the drying wheel assembly in a first rotation in response to the first position signal;
generating, with the vehicle position sensor, a second position signal representing a vehicle in a second position relative to the drying wheel assembly; and
supplying, with the controller, a second drive signal to the rotary actuator for horizontally rotating the drying wheel assembly in a second rotation when the vehicle is in the second position, the second rotation being opposite of the first rotation.

13. The method of claim 12, wherein the second rotation further includes a change in rotation speed.

14. The method of claim 13, wherein the first rotation is opposite to a direction of vehicle travel, and wherein the second rotation is in a direction of vehicle travel.

15. The method of claim 12, wherein the second position corresponds to alignment between the wheel axis and an exterior feature of the vehicle.

16. The method of claim 15, wherein the exterior feature of the vehicle is further defined as an exterior mirror.

17. The method of claim 12, further comprising a step of supplying, with the controller, a third drive signal to the rotary actuator for rotating the drying wheel assembly in a third rotation when the vehicle is in a third position.

18. The method of claim 12, wherein a torque measurement of the rotary actuator is communicated to the control system.

19. The method of claim 12, further comprising measuring torque of the rotary drying wheel assembly and stopping or reversing the rotary drying wheel assembly in response to the torque measurement.

20. The method of claim 12, wherein the control system is in communication with a vehicle height sensor adapted to measure the height of a vehicle as the vehicle travels through a carwash.

21. A method of operating a drying system including a horizontal drying wheel assembly rotatable by a rotary actuator about a wheel axis and having a pair of outer drying elements defined by a first diameter and an inner drying element defining a second diameter less than the first diameter arranged between the pair of outer drying elements for drying a vehicle in an automated wash facility and further including a control system having a controller and a vehicle height sensor in communication with the controller, the method comprising:
determining a height of a front portion of a vehicle with the vehicle height sensor as the vehicle moves through the wash facility in proximity to the vehicle height sensor;
setting a beginning height of the horizontal drying wheel assembly in response to the determination of the height of the front portion of the vehicle; and
horizontally rotating the drying wheel assembly to dry the vehicle as the vehicle moves in proximity to the drying wheel assembly.

22. The method of operating a drying system of claim 21 further comprising:
continuing to determine a height of additional portions of the vehicle with the vehicle height sensor as the vehicle moves through the wash facility in proximity to the vehicle height sensor; and
continuing to adjust the height of the horizontal drying wheel assembly in response to the determination of the height of the additional portions of the vehicle as the vehicle moves through the wash facility in proximity to the vehicle height sensor.
